(19) United States
(12) Patent Application Publication
(10) Pub. No.: US 2026/0024942 A1
(43) Pub. Date: Jan. 22, 2026

(54) ELECTRIC WORK MACHINE AND CORD GUARD

(71) Applicant: MAKITA CORPORATION, Anjo-shi (JP)

(72) Inventor: Manaki NAKADA, Anjo-shi (JP)

(73) Assignee: MAKITA CORPORATION, Anjo-shi (JP)

(21) Appl. No.: 19/268,336

(22) Filed: Jul. 14, 2025

(30) Foreign Application Priority Data
Jul. 18, 2024 (JP) 2024-114928

(51) Int. Cl. H01R 13/56; B25D 16/00; B25F 5/02

(52) U.S. Cl. CPC H01R 13/562; B25D 16/00; B25F 5/026

(57) ABSTRACT

The electric work machine includes a housing, a motor, a power cord, and a cord guard. The cord guard includes an internal space, a coupling portion, an exit portion, and an intermediate portion. The coupling portion is coupled to the cord outlet. The power cord passes through the internal space and is exposed to an outside from the exit portion. The intermediate portion is located between the coupling portion and the exit portion and includes large-diameter portions and small-diameter portions. Outer diameters of the small-diameter portions are smaller than outer diameters of the large-diameter portions. The large-diameter portions each have a first length in an extending direction of the cord guard. The small-diameter portions each have a second length in the extending direction, and the second length is shorter than the first length.

### CROSS-REFERENCE TO RELATED APPLICATION

This application claims the benefit of Japanese Patent Application No. 2024-114928 filed on Jul. 18, 2024 with the Japan Patent Office, the entire disclosure of which is incorporated herein by reference.

### BACKGROUND

The present disclosure relates to a technique for improving flexural strength of a cord guard.

A cord guard for a hand tool described in German Patent Application Publication No. 102010031307 includes large-diameter portions having large outer diameters and small-diameter portions having small outer diameters. The large-diameter portions and the small-diameter portions have the same width, and are arranged alternately one after the other in an extending direction of the cord guard.

### SUMMARY

Since the cord guard for the hand tool is bent at nearly a right angle, a very large load is applied to a bent portion. Thus, if the user uses the hand tool on a daily basis, the load accumulates on the cord guard and on a power cord inside the cord guard. As a result, the cord guard or the power cord may be damaged and/or broken sooner than expected.

One aspect of the present disclosure provides a technique for improving the flexural strength of the cord guard.

An electric work machine according to one aspect of the present disclosure includes a housing, a motor, a power cord, and a cord guard. The housing includes a cord outlet. The motor is housed in the housing. The power cord is drawn out from the cord outlet, and configured to be connected to an external power supply to supply electric power from the external power supply to the motor. The cord guard includes an internal space, a coupling portion, an exit portion, and an intermediate portion. The internal space is a space through which the power cord passes. The coupling portion is formed to be coupled to the cord outlet. The exit portion is a portion from which the power cord is exposed to an outside. The intermediate portion is located between the coupling portion and the exit portion and includes large-diameter portions and small-diameter portions. Outer diameters of the small-diameter portions are smaller than outer diameters of the large-diameter portions. The large-diameter portions each have a first length in an extending direction of the cord guard. The small-diameter portions each have a second length in the extending direction, and the second length is shorter than the first length.

In the aforementioned electric work machine, the second length is shorter than the first length in the cord guard. This configuration enables two adjacent large-diameter portions to come into contact with each other when the cord guard is bent, thereby inhibiting excessive reduction in radius of curvature of the cord guard. Accordingly, flexural strength (or bending resistance) of the cord guard is improved. Further, the load applied to the power cord is reduced and durability of the power cord is improved.

A cord guard according to another aspect of the present disclosure is configured to be attached to a power cord drawn out from a cord outlet of a housing. The cord guard includes an internal space, a coupling portion, an exit portion, and an intermediate portion. The internal space allows the power cord to pass therethrough. The coupling portion is configured to be coupled to the cord outlet. The exit portion allows the power cord to be exposed to an outside. The intermediate portion is located between the coupling portion and the exit portion and includes large-diameter portions and small-diameter portions. Outer diameters of the small-diameter portions are smaller than outer diameters of the large-diameter portions. The large-diameter portions each have a first length in an extending direction of the cord guard. The small-diameter portions each have a second length in the extending direction, and the second length is shorter than the first length. The aforementioned cord guard produces the same effects as those produced by the aforementioned electric work machine.

### BRIEF DESCRIPTION OF THE DRAWINGS

An example embodiment of the present disclosure will be described hereinafter with reference to the accompanying drawings, in which:

FIG. 1 is a view showing an appearance of an electric work machine according to a present embodiment;

FIG. 2 is a sectional view of the electric work machine according to the present embodiment;

FIG. 3 is a side view showing the appearance of the cord guard according to the present embodiment;

FIG. 4 is a perspective view showing the appearance of the cord guard according to the present embodiment;

FIG. 5 is a sectional view of a coupling portion of the cord guard according to the present embodiment;

FIG. 6 is a schematic diagram showing a length of large-diameter portions and a length of small-diameter portions of the cord guard according to the present embodiment;

FIG. 7A is a side view of the cord guard according to the present embodiment when a first load is applied to the cord guard;

FIG. 7B is an enlarged view of an intermediate portion of the cord guard according to the present embodiment when the first load is applied to the cord guard;

FIG. 7C is a sectional view of the intermediate portion of the cord guard according to the present embodiment when the first load is applied to the cord guard;

FIG. 8A is a side view of the cord guard according to the present embodiment when a second load, which is lighter than the first load, is applied to the cord guard;

FIG. 8B is a sectional view of the cord guard according to the present embodiment when the second load is applied to the cord guard;

FIG. 9 is a diagram showing bending lines for the cord guard according to the present embodiment;

FIG. 10A is a diagram showing the cord guard in a bent state according to a first reference example;

FIG. 10B is an enlarged view of a part of the cord guard according to the first reference example;

FIG. 11A is a diagram showing the cord guard in a bent state according to a second reference example;

FIG. 11B is an enlarged view of a part of the cord guard according to the second reference example;

FIG. 11C is an enlarged view of another part of the cord guard according to the second reference example; and

FIG. 12 is a diagram showing a section of the cord guard according to a third reference example.

### DETAILED DESCRIPTION OF EXEMPLARY EMBODIMENTS

### Overview of Embodiments

One embodiment may provide an electric work machine including at least any one of the following features:
Feature 1: A housing including a cord outlet.
Feature 2: A motor housed in the housing.
Feature 3: A power cord drawn out from the cord outlet, and configured to be connected to an external power supply to supply electric power from the external power supply to the motor.
Feature 4: A cord guard.
Feature 5: The cord guard has an internal space through which the power cord passes.
Feature 6: The cord guard includes a coupling portion formed to be coupled to the cord outlet.
Feature 7: The cord guard includes an exit portion from which the power cord is exposed to an outside.
Feature 8: The cord guard includes an intermediate portion located between the coupling portion and the exit portion.
Feature 9: The intermediate portion includes large-diameter portions and small-diameter portions.
Feature 10: Outer diameters of the small-diameter portions are smaller than outer diameters of the large-diameter portions.
Feature 11: The large-diameter portions each have a first length in an extending direction of the cord guard.
Feature 12: The small-diameter portions each have a second length in the extending direction.
Feature 13: The second length is shorter than the first length.

In the electric work machine including at least the features 1 through 13, the second length is shorter than the first length in the cord guard. This configuration enables two adjacent large-diameter portions to come into contact with each other when the cord guard is bent, thereby inhibiting excessive reduction in radius of curvature of the cord guard. Accordingly, flexural strength of the cord guard is improved. Further, damage to the cord guard is reduced. Furthermore, tearing of the cord guard, which may otherwise lead to exposure or breakage of the power cord, is suppressed, thereby improving durability of the power cord.

One embodiment may include the following feature in addition to or in place of at least any one of the features 1 through 13.
Feature 14: The exit portion has a first inner diameter, and the first inner diameter increases with distance from the intermediate portion.

In the electric work machine including at least the features 1 through 14, an inner diameter of the exit portion increases with distance from the intermediate portion. This configuration allows the power cord to be bent flexibly along an inner surface of the exit portion. Further, this configuration makes it possible to inhibit breakage of the power cord caused by localized concentration of the load on the power cord in the exit portion. Furthermore, when working with the electric work machine, an ability of the power cord to follow movements of the electric work machine is improved, so that the user can use the electric work machine in a comfortable manner.

One embodiment may include at least one of the following features in addition to or in place of at least any one of the features 1 through 14.
Feature 15: The cord outlet has an inner circumferential surface.
Feature 16: The housing includes a protrusion that protrudes inward from the inner circumferential surface of the housing.
Feature 17: The coupling portion includes a recess that is recessed inward in a radial direction of the cord guard and is configured to be engaged with the protrusion.

In the electric work machine including at least the features 1 through 13 and 15 through 17, the cord guard is supported by the protrusion of the housing. With this configuration, the load of the electric work machine is distributed to the cord guard and to the housing, resulting in improvement of the flexural strength of the cord guard. Especially when the load applied to the power cord and the cord guard is relatively heavy, this configuration makes it possible to improve the flexural strength of the cord guard.

One embodiment may include the following feature in addition to or in place of at least any one of the features 1 through 17.
Feature 18: A portion including the large-diameter portions and the small-diameter portions is arranged to be on or closer to the center of the intermediate portion than to the coupling portion and to the exit portion.

In the electric work machine including at least features 1 through 13 and 18, the portion including the large-diameter portions and the small-diameter portions is arranged to be on or closer to the center of the intermediate portion than to the coupling portion and to the exit portion. This configuration makes it possible to maintain strength of one side of the intermediate portion, which is closer to the coupling portion, and an other side of the intermediate portion, which is closer to the exit portion, both of which are subjected to the load of the electric work machine. Further, it is possible to maintain durability of the cord guard.

One embodiment may include at least one of the following features in addition to or in place of at least any one of the features 1 through 18.
Feature 19: The power cord has a first outer diameter.
Feature 20: The intermediate portion has a second inner diameter that is larger than the first outer diameter.

In the electric work machine including at least the features 1 through 13 and 19 through 20, the intermediate portion has an inner diameter that is larger than an outer diameter of the power cord. This configuration makes it possible to detach the cord guard from the power cord. Further, it is possible to replace the cord guard when the cord guard is worn out.

One embodiment may include the following feature in addition to or in place of at least any one of the features 1 through 20.
Feature 21: The first length is three times the second length.

In the electric work machine including at least the features 1 through 13 and 21, the first length is three times the second length. This configuration provides an optimum radius of curvature when the cord guard is bent. Additionally, the flexural strength of the cord guard is further improved.

One embodiment may include the following feature in addition to or in place of at least any one of the features 1 through 21.
Feature 22: The second length is 1 mm or more.

In the electric work machine including at least the features 1 through 13 and 22, the second length is 1 mm or more. This configuration makes it possible to inhibit the small-diameter portions from being torn apart by the load of the electric work machine. Further, this configuration allows flexible bending of the cord guard while still maintaining the durability of the cord guard.

Examples of the electric work machine may include various kinds of devices for use in construction, manufacturing, gardening, civil engineering, and other work sites, specifically electric power tools for masonry work, metalworking, and woodworking, electric power tools for gardening, electric power tools for preparing an environment of job sites, fan vests, fan jackets, hand-pushed carriers, electric assist bicycles, and air pumps.

Examples of the aforementioned electric power tools may include electric chainsaws, electric hand saws, electric blowers, electric hammers, electric hammer drills, electric drills, electric drivers, electric wrenches, electric impact drivers, electric impact wrenches, electric grinders, electric circular saws, electric reciprocating saws, electric jig saws, electric cutters, electric planes, electric nail guns (including rivet guns), electric hedge trimmers, electric lawn mowers, electric lawn clippers, electric brush cutters, electric cleaners, electric sprayers, electric spreaders, electric dust collectors, electric trowels, electric vibrators, electric rummers, electric compactors, electric pumps, electric pile driving machine, electric concrete saws, electric screeds, electric cut-off saws.

One embodiment may provide the cord guard including at least any one of the features 4 through 22.

In one embodiment, the features 1 through 22 may be combined in any combination.

In one embodiment, some of the features 1 through 22 may be excluded.

### Specific Example Embodiments

Example embodiments of the present disclosure will be described below with reference to the drawings.

### <1. Overall Configuration>

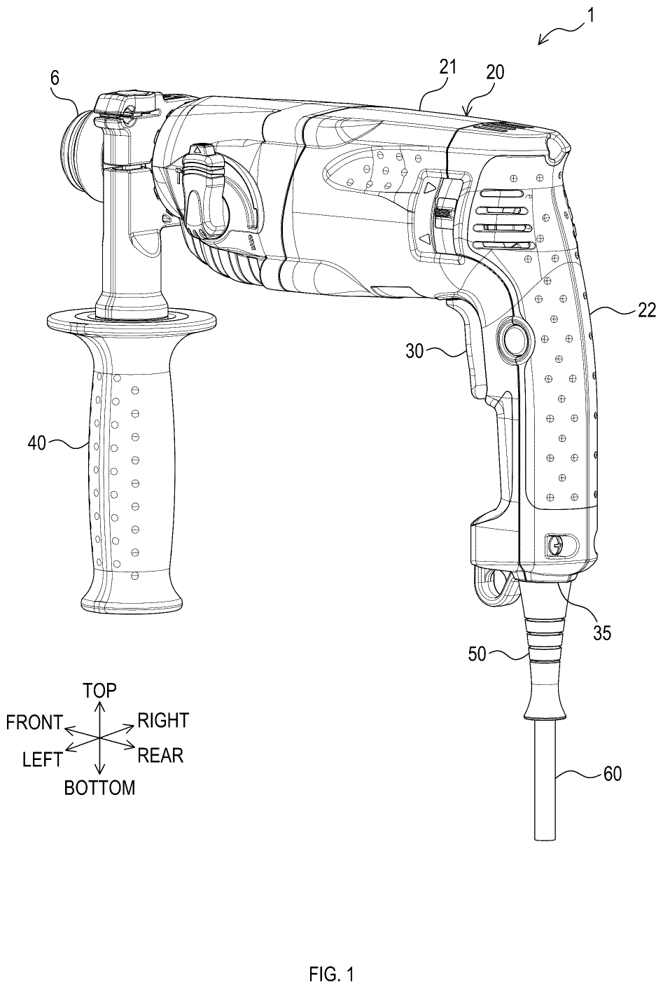

A description will be given of an electric work machine 1 according to the present embodiment with reference to FIG. 1. The electric work machine 1 is an electric hammer drill. The electric hammer drill is a type of electric power tool.

The electric work machine 1 includes a housing 20. The housing 20 forms an outer body of the electric work machine 1. The housing 20 includes a main body 21 and a handgrip 22.

The main body 21 has a rectangular parallelepiped shape. The main body 21 includes a first end and a second end. The first end is one of two ends of the main body 21 in a longitudinal direction of the main body 21. The second end is the other of the two ends of the main body 21 in the longitudinal direction of the main body 21. The handgrip 22 is coupled to the first end of the main body 21 and extends from the first end. Hereinafter, the longitudinal direction of the main body 21 is referred to as a front-rear direction, an extending direction of the handgrip 22 is referred to as an up-down direction, and a direction perpendicular to both the front-rear direction and the up-down direction is referred to as a left-right direction.

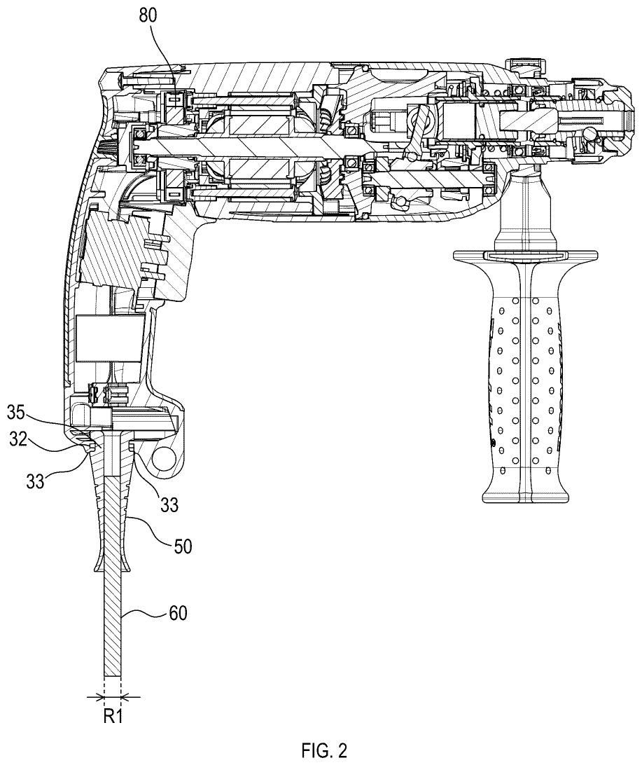

As shown in FIG. 2, the electric work machine 1 includes a motor 80 that is housed in the main body 21. Examples of the motor 80 include a three-phase brushless motor and a three-phase brushed motor. The motor 80 receives electric power and rotates.

The electric work machine 1 includes a tool holder 6. The tool holder 6 is arranged on the second end of the main body 21. The tool holder 6 holds a tip tool such as a drill bit. The tip tool receives a driving force generated by rotation of the motor 80 and then moves linearly and/or rotationally.

The electric work machine 1 includes a side handle 40. The side handle 40 is fixed to the second end of the main body 21 and extends in the up-down direction. The user uses the electric work machine 1 by gripping the handgrip 22 and the side handle 40.

The electric work machine 1 includes a trigger 30. The trigger 30 is arranged on a front surface of the handgrip 22. The user operates the trigger 30 to drive or stop the motor 80. Specifically, when the user pulls the trigger 30, the motor 80 is driven. When the user releases the trigger 30, the motor 80 is stopped.

The electric work machine 1 includes a power cord 60. The power cord 60 is electrically connected to the motor 80 and drawn out from a cord outlet 35 formed on the housing 20. As shown in FIG. 2, the cord outlet 35 is formed on an underside of the handgrip 22 and is a substantially cylindrical hollow. The cord outlet 35 has a circular shape in a plane perpendicular to the up-down direction. The power cord 60 is connected to an external power supply to supply the electric power from the external power supply to the motor 80. The external power supply includes a single-phase AC power supply, a three-phase AC power supply, and an installed or portable energy storage device.

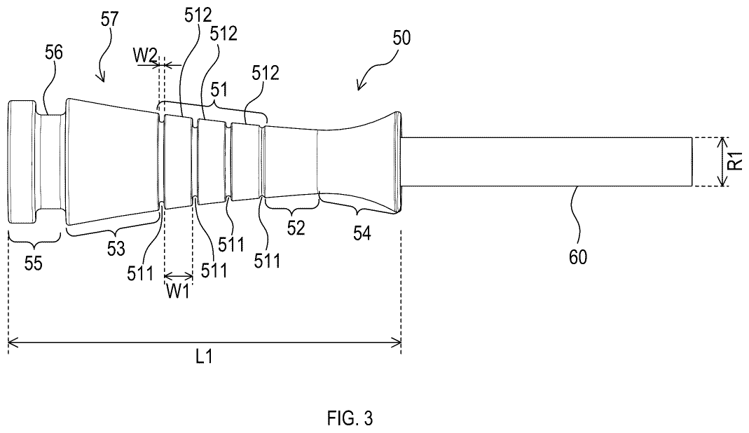

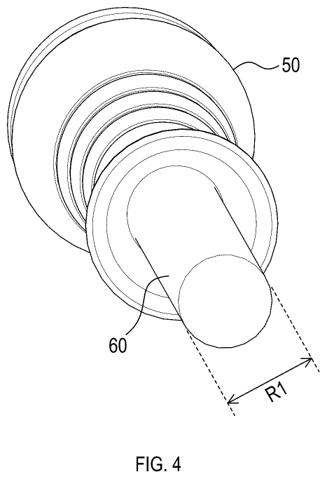

As shown in FIGS. 3 and 4, a horizontal cross section of the power cord 60 has a circular shape with an outer diameter R1. The horizontal cross section is orthogonal to an extension direction of the power cord 60. The horizontal section of the power cord 60 may have any shape, not limited to the circular shape, as long as it does not have a corner. For example, the horizontal cross section of the power cord 60 may have an oval shape. In the present embodiment, the outer diameter R1 corresponds to one example of the first outer diameter described in Overview of Embodiments.

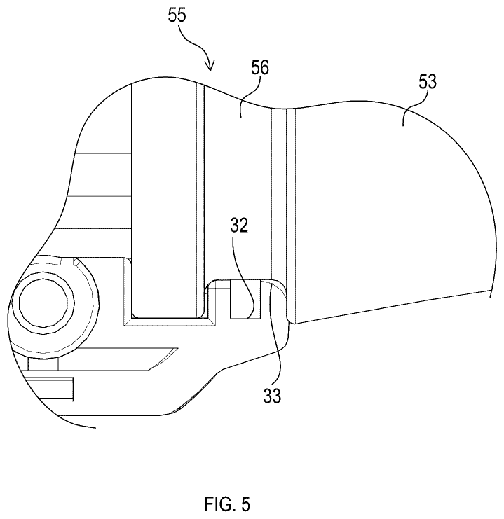

The housing 20 includes a rib 33. The cord outlet 35 has an inner circumferential surface 32. As shown in FIGS. 2 and 5, the rib 33 is arranged inside the housing 20. Specifically, the rib 33 protrudes inward from the inner circumferential surface 32 of the cord outlet 35. The rib 33 is arranged along an entire circumference of the inner circumferential surface 32 of the cord outlet 35 in a circumferential direction of the inner circumferential surface 32. In another embodiment, the rib 33 does not need to be arranged along the entire circumference of the inner circumferential surface 32. For example, the rib 33 may include protrusions, and the protrusions may be arranged in the circumferential direction of the inner circumferential surface 32 with specified intervals. In the present embodiment, the rib 33 corresponds to one example of the protrusion described in Overview of Embodiments.

The electric work machine 1 includes a cord guard 50. The cord guard 50 has a substantially tubular shape with an internal space 58. The cord guard 50 is coupled (attached) to the cord outlet 35 of the housing 20. The power cord 60 passes through the internal space of the cord guard 50. A load of the electric work machine 1 is applied to the power cord 60 in the vicinity of the cord outlet 35, thus making the power cord 60 prone to breakage and/or damage. The cord guard 50 protects the part of the power cord 60 that is prone to breakage and/or damage.

### <2. Configuration of Cord Guard>

Next, a description will be given of a configuration of the cord guard 50 according to the present embodiment. The cord guard 50 is made of an insulating material. For example, the cord guard 50 is made of rubber material such as ethylene propylene diene rubber or urethane rubber, or polyvinyl chloride.

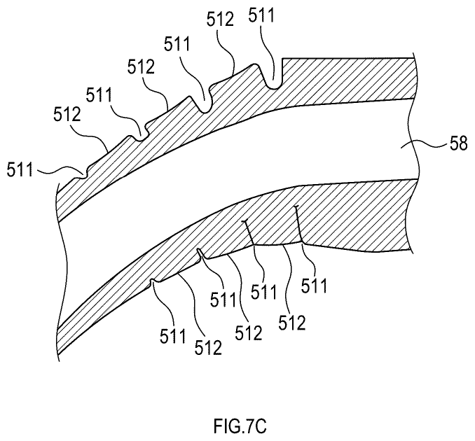

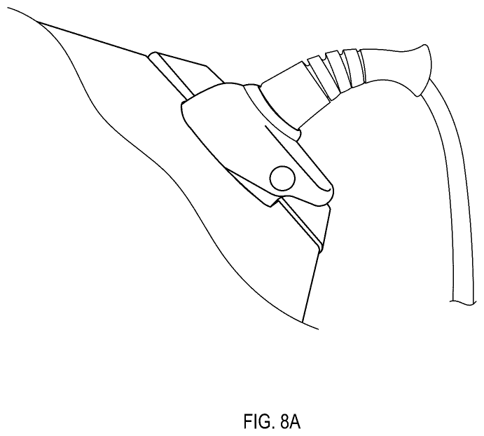

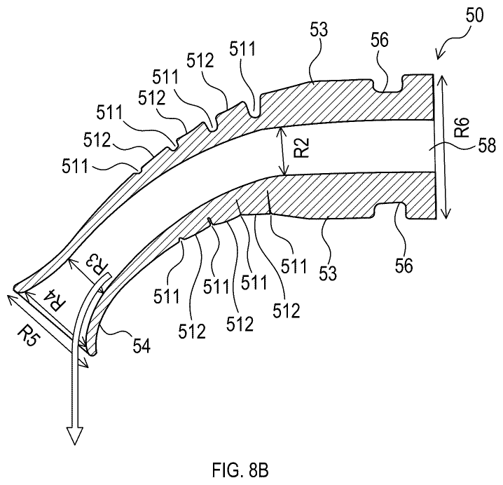

As shown in FIG. 8B, the cord guard 50 is a substantially tubular member with the internal space 58. The internal space 58 allows the power cord 60 to pass therethrough. The internal space 58 has a substantially cylindrical shape. The cord guard 50 has an inner diameter R2. The inner diameter R2 corresponds to a diameter of the internal space 58. The inner diameter R2 is a diameter of the narrowest part of the internal space 58 and corresponds to a minimum inner diameter of the cord guard 50. The inner diameter R2 is larger than the outer diameter R1. Accordingly, the cord guard 50 is not closely adhered to the power cord 60 and there is a gap between an inner surface of the cord guard 50 and an outer surface of the power cord 60. This configuration makes it possible to detach the cord guard 50 from the power cord 60. In the present embodiment, the inner diameter R2 corresponds to one example of the second inner diameter described in Overview of Embodiments.

As shown in FIG. 3, the cord guard 50 has a length L1 in its extension direction. The length L1 is at least five times the inner diameter R2. The cord guard 50 includes a coupling portion 55, an intermediate portion 57, and an exit portion 54. The coupling portion 55 is located proximal to the housing 20, and the exit portion 54 is located distal to the housing 20. The intermediate portion 57 is located between the coupling portion 55 and the exit portion 54, and is contiguous to the coupling portion 55 and to the exit portion 54.

The coupling portion 55 is coupled to the cord outlet 35 of the housing 20. The coupling portion 55 is inserted into the cord outlet 35 and arranged inside the housing 20. In particular, the coupling portion 55 includes a groove 56. The groove 56 is recessed inward in a radial direction of the coupling portion 55 from an outer surface of the coupling portion 55. The radial direction of the coupling portion 55 corresponds to a radial direction of the cord guard 50. The groove 56 is arranged along an entire circumference of the outer surface of the coupling portion 55 in a circumferential direction of the outer surface. As shown in FIGS. 2 and 5, the groove 56 is engaged with the rib 33 of the housing 20. By inserting the coupling portion 55 into the cord outlet 35 and engaging the groove 56 with the rib 33, the cord guard 50 is fixed to the housing 20. In the present embodiment, the groove 56 corresponds to one example of the recess described in Overview of Embodiments.

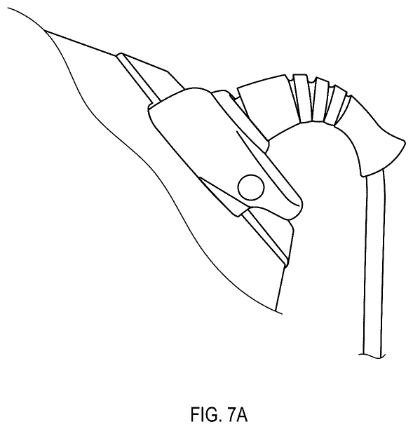

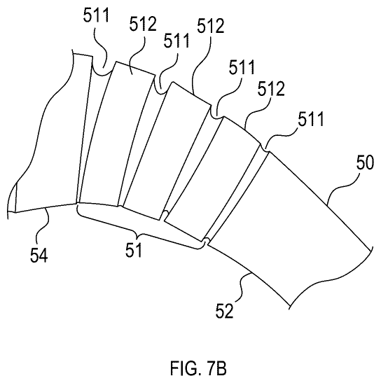

The intermediate portion 57 has an outer diameter that generally decreases from a part adjacent to the coupling portion 55 toward the exit portion 54. More specifically, the outer diameter of the intermediate portion 57 decreases from the part adjacent to the coupling portion 55 toward the exit portion 54, except small-diameter portions 511 that will be described below. As shown in FIGS. 7C and 8B, the intermediate portion 57 has a uniform inner diameter. Accordingly, a member of the intermediate portion 57 is generally thinner from the part adjacent to the coupling portion 55 toward the exit portion 54. More specifically, the member of the intermediate portion 57 is thinner from the part adjacent to the coupling portion 55 toward the exit portion 54, except where the small-diameter portions 511 are.

The intermediate portion 57 includes a bellows portion 51, a first flat portion 53, and a second flat portion 52. The first flat portion 53 is contiguous to the coupling portion 55. The second flat portion 52 is contiguous to the exit portion 54. The bellows portion 51 is a center portion of the intermediate portion 57 and is located between the first flat portion 53 and the second flat portion 52.

The bellows portion 51 includes large-diameter portions 512 and the small-diameter portions 511. Outer diameters of the small-diameter portions 511 are smaller than outer diameters of the large-diameter portions 512. As shown in FIG. 3, the small-diameter portions 511 and the large-diameter portions 512 are arranged alternately one after another in an extending direction of the cord guard 50.

The small-diameter portions 511 each correspond to a recess that is recessed inward in the radial direction of the cord guard 50 from an outer surface of the cord guard 50. The small-diameter portions 511 are each arranged along an entire circumference of the outer surface of the cord guard 50 in a circumferential direction of the outer surface of the cord guard 50. Portions formed between the recess and its adjacent recess on the outer surface of the cord guard 50 correspond to the large-diameter portions 512. The first flat portion 53 and the second flat portion 52 do not include recesses that could correspond to the small-diameter portions 511. In other words, a portion including the large-diameter portions 512 and the small-diameter portions 511 is arranged to be on or closer to a center of the intermediate portion 57 than to the coupling portion 55 and to the exit portion 54. In the present embodiment, the bellows portion 51 includes four small-diameter portions 511 and three large-diameter portions 512.

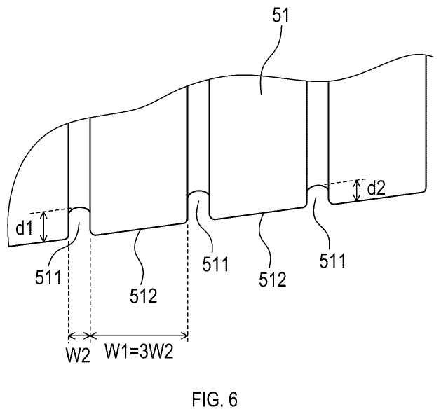

Since the bellows portion 51 is arranged on or closer to the center of the cord guard 50, the cord guard 50 can be bent flexibly. As shown in FIG. 6, the large-diameter portions 512 each have a first length (width) W1 in the extending direction of the cord guard 50. The small-diameter portions 511 each have a second length (width) W2 in the extending direction of the cord guard 50. The second length W2 is shorter than the first length W1. Preferably, the first length W1 is three times the second length W2. This ratio of the lengths provides an optimum radius of curvature of the cord guard 50 when the cord guard 50 is bent.

It is also preferable that the second length W2 be 1 mm or more. If the second length W2 is too short, cracks may appear in the cord guard 50 when the cord guard 50 is bent. By setting the second length W2 to be 1 mm or more, the small-diameter portions 511 are inhibited from being torn apart when the cord guard 50 is bent.

As shown in FIG. 3, the outer diameters of the large-diameter portions 512 decrease from a portion adjacent to the first flat portion 53 toward the second flat portion 52. The outer diameters of the small-diameter portions 511 are all equal. The outer diameters of the small-diameter portions 511 may be different from each other. The small-diameter portions 511 each have sufficient thickness to maintain insulation properties of the small-diameter portions 511. Accordingly, a difference also decreases from the portion adjacent to the first flat portion 53 toward the second flat portion 52. The difference corresponds to a positional difference between an outer surface of one of the large-diameter portions 512 and an outer surface of one of the small-diameter portions 511, which is adjacent to the one of the large-diameter portions 512. Specifically, as shown in FIG. 6, the grooves that correspond to the small-diameter portions 511 are shallower from the portion adjacent to the first flat portion 53 toward the second flat portion 52. One of the small-diameter portions 511 that is adjacent to the first flat portion 53 corresponds to a groove having a depth d1. One of the small-diameter portions 511 that is adjacent to the second flat portion 52 corresponds to a groove having a depth d2, and the depth d2 is smaller than the depth d1.

The exit portion 54 is contiguous to the second flat portion 52. The power cord 60 is exposed to an outside from the exit portion 54. As shown in FIGS. 3 and 8B, an inner circumferential surface and an outer circumferential surface of the exit portion 54 are trumpet-shaped (or flare-shaped or funnel-shaped) and the exit portion 54 widens with distance from the second flat portion 52. In other words, an inner diameter and an outer diameter of the exit portion 54 increase with distance from the intermediate portion 57.

The exit portion 54 includes a first end and a second end. As shown in FIG. 8B, the first end is contiguous to the second flat portion 52 and has an inner diameter R3. The second end faces the first end, and the power cord 60 is exposed to the outside from the second end. The second end has an inner diameter R4, which is larger than the inner diameter R3, and an outer diameter R5. Meanwhile, the coupling portion 55 has an outer diameter R6 at its end, and the outer diameter R6 is twice or about twice as long as the outer diameter R5. The power cord 60 that extends from the inside of the housing 20 through the cord guard 50 is guided by the trumpet-shaped inner circumferential surface of the exit portion 54, and then exposed to the outside.

### <2-1. Bending Under Heavy Load>

Next, with reference to FIGS. 7A, 7B, and 7C, a description is given of bending of the cord guard 50 when a first load is applied to the cord guard 50. FIG. 7A shows bending of the cord guard 50 when the electric work machine 1 is fixed and a first weight is suspended from the power cord 60. The first weight has the first load. The first load is relatively large and has about the same weight as the electric work machine 1, for example, 4 kg.

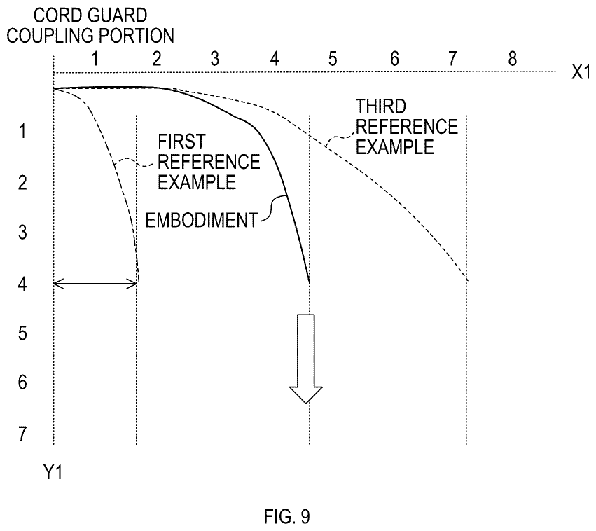

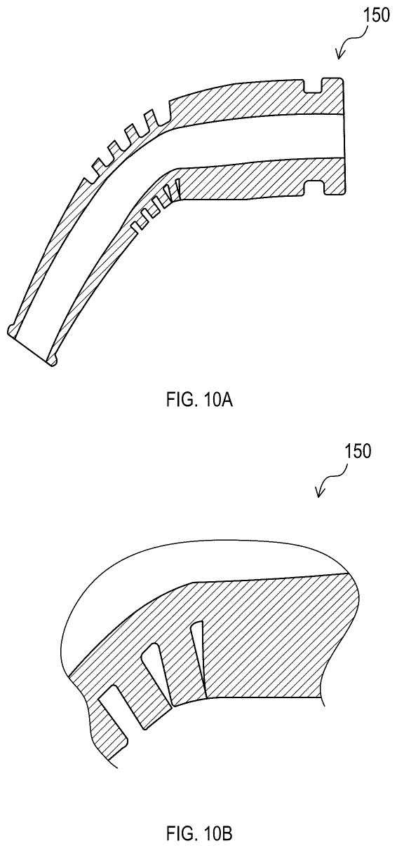

When the first load is applied to the cord guard 50, the load is applied to a side of the cord guard 50 proximal to the electric work machine 1. In a cord guard 150 according to a first reference example shown in FIGS. 10A and 10B, a length of small-diameter portions is equal to a length of large-diameter portions. For this reason, in the first reference example, the load applied to the cord guard 150 is not distributed over the large-diameter portions and is concentrated locally. Further, as shown by a bending line for the first reference example in FIG. 9, the cord guard 150 is bent at a sharp angle in an area proximal to the electric work machine and a radius of curvature of the cord guard 150 becomes excessively small. As a result, daily use of the electric work machine by the user may cause the power cord to be broken sooner than expected. A horizontal axis in FIG. 9 indicates a distance from an end of the coupling portion 55 in a horizontal direction. A vertical axis in FIG. 9 indicates a distance from the end of the coupling portion 55 in a vertical direction. The horizontal direction is the extending direction of the cord guard 50. The vertical direction is a direction perpendicular to the extending direction.

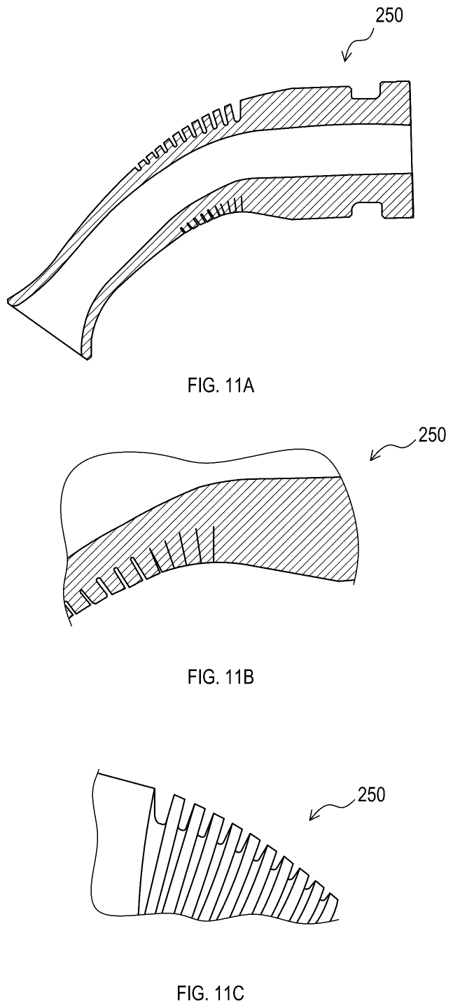

In a cord guard 250 according to a second reference example shown in FIGS. 11A to 11C, a length of small-diameter portions is equal to a length of large-diameter portions, and the length of the small-diameter portions and the large-diameter portions is shorter than the length of the large-diameter portions and the small-diameter portions of the cord guard 150 according to the first reference example. Specifically, the length of the large-diameter portions and the small-diameter portions of the cord guard 250 is less than 1 mm. In the second reference example, the load applied to the cord guard 50 is distributed over the large-diameter portions. However, when the load is applied to the cord guard 250, the small-diameter portions may be torn apart. Specifically, when the length of the small-diameter portions is excessively short, the load applied to the cord guard 250 may exceed tensile strength of the cord guard 250, causing cracks to appear in the cord guard 250.

To solve the aforementioned problem that may occur when a relatively heavy load is applied to the cord guard 50, the inventors have studied the shape of the cord guard 50. As a result of the study, the inventors have found that setting the second length W2 of the small-diameter portions 511 to be shorter than the first length W1 of the large-diameter portions 512 inhibits excessive reduction in the radius of curvature of the cord guard 50 when the cord guard 50 is bent. Specifically, as shown in FIGS. 7B and 7C, by setting the second length W2 to be shorter than the first length W1, the load applied to the cord guard 50 is distributed over the large-diameter portions 512, and two adjacent large-diameter portions 512 come into contact with each other. Accordingly, the cord guard 50 is inhibited from being bent sharply.

In particular, as a result of the study, the inventors have found that, by setting the first length W1 to be three times the second length W2, the radius of curvature of the cord guard 50 becomes optimum when the cord guard 50 is bent. It is further found that this achieves an ideal bending of the cord guard 50, as shown in FIG. 9 by a bending line for the cord guard 50 according to the present embodiment. More specifically, a distance X1 in the horizontal direction of the cord guard 50 corresponds to a distance Y1 in the vertical direction of the cord guard 50, and the distance X1 is substantially equal to the distance Y.

As a result of a further study, the inventors have found that setting the second length W2 to be 1 mm or more inhibits occurrence of breakage at the small-diameter portions 511 even when a relatively heavy load is applied to the cord guard 50. Furthermore, by supporting the coupling portion 55 by the rib 33, the load is distributed to the cord guard 50 and to the housing 20, resulting in an improvement of a flexural strength of the cord guard 50.

### <2-2. Bending Under Light Load>

With reference to FIGS. 8A and 8B, a description is given of bending of the cord guard 50 when a second load is applied to the cord guard 50. FIG. 8A shows bending of the cord guard 50 when the electric work machine 1 is fixed and a second weight is suspended from the power cord 60. The second weight has the second load. The second load is relatively small and weighs less than the first load. The second load is, for example, 1 kg.

When the second load is applied to the cord guard 50, the load is applied to a side of the cord guard 50 distal to the electric work machine 1, that is, to the exit portion 54.

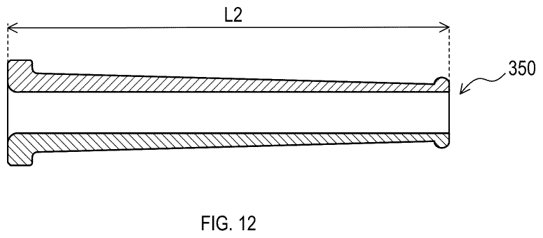

A cord guard 350 according to a third reference example shown in FIG. 12 has a length L2 in an extending direction of the cord guard 350. The length L2 is longer than the length L1. Since the cord guard 350 is big in full-length size, the cord guard 350 is bent flexibly as a whole. This configuration inhibits the power cord from being bent sharply at the exit portion. Further, the big size of the cord guard 350 in full length inhibits the power cord from being broken at the exit portion of the cord guard 350. However, when a quite light load is applied to the cord guard 350, the cord guard 350 is not bent flexibly as a whole as shown by a bending line for the cord guard 350 in the third reference example in FIG. 9. Thus, the power cord is bent at a sharp angle at the exit portion of the cord guard 350, thereby increasing the likelihood of breakage.

Further, if the length L2 is longer, a larger space will be required to store the electric work machine 1. As a result, the electric work machine 1 will need a larger storage case. Furthermore, in order for the cord guard 350 to adapt to a relatively heavy electric work machine 1, the cord guard 350 will be required to have a thicker coupling portion. In such a case, the cord guard 350 will be much bigger in size, and the space required to store the electric work machine 1 will be much larger.

To solve the aforementioned problem that may occur when a relatively light load is applied to the cord guard 50, the inventors have studied the shape of the cord guard 50. As a result of the study, the inventors have found that, by forming the inner circumferential surface of the exit portion 54 into the trumpet shape, the power cord 60 obtains a modified angle at the exit portion 54 and is inhibited from being bent at a sharp angle. In other words, the inventors have found that, by forming the inner circumferential surface of the exit portion 54 into a shape with an ideal radius of curvature, the power cord 60 is bent at an ideal angle along the inner circumferential surface of the exit portion 54.

### <3. Effects>

With the present embodiment detailed above, the following effects can be obtained.

(1) The second length W2 is shorter than the first length W1. This configuration allows the two adjacent large-diameter portions 512 to come into contact with each other when the cord guard 50 is bent, thereby inhibiting excessive reduction in the radius of curvature of the cord guard 50. Accordingly, the flexural strength of the cord guard 50 is improved. Further, the cord guard 50 is inhibited from being damaged. Furthermore, the power cord 60 is inhibited from being exposed and/or broken due to damage to the cord guard 50, resulting in an improved durability of the power cord 60.

(2) The inner diameter of the exit portion 54 increases with distance from the intermediate portion 57. With this configuration, the power cord 60 is bent flexibly along the inner circumferential surface of the exit portion 54. This makes it possible to inhibit breakage of the power cord 60 caused by a localized concentration of the load on the power cord 60 at the exit portion 54. Further, when working with the electric work machine 1, an ability of the power cord 60 to follow movements of the electric work machine 1 is improved. Accordingly, the user can use the electric work machine 1 in a comfortable manner.

(3) Since the rib 33 of the housing 20 supports the cord guard 50, the load applied to the cord guard 50 is distributed to the cord guard 50 and to the housing 20. This configuration improves the flexural strength of the cord guard 50. In particular, when a load applied to the cord guard 50 is relatively heavy, this configuration improves the flexural strength of the cord guard 50.

(4) The portion including the large-diameter portions 512 and the small-diameter portions 511 is arranged to be on or closer to the center of the intermediate portion 57 than to the coupling portion 55 and to the exit portion 54. This configuration makes it possible to maintain the strength of the first flat portion 53 and the second flat portion 52, to which the load is applied. Further, it is possible to maintain the durability of the cord guard 50.

(5) Since the inner diameter R2 of the cord guard 50 is larger than the outer diameter R1 of the power cord 60, the cord guard 50 can be detached from the power cord 60. Further, it is possible to replace the cord guard 50 when the cord guard 50 is worn out.

(6) By setting the second length W2 to be 1 mm or more, it is possible to inhibit the small-diameter portions 511 from being torn apart by the load applied to the cord guard 50. Further, this configuration allows the cord guard 50 to be bent flexibly while still maintaining the durability of the cord guard 50.

(7) The cord guard 50 includes the bellows portion 51 and the exit portion 54, which is formed in the trumpet shape. This configuration enables the cord guard 50 to adapt to both the relatively heavy load and the relatively light load while making the cord guard 50 smaller.

### Other Embodiments

While the embodiments of the present disclosure have been described so far, the present disclosure can be implemented in variously modified manners without being limited to the aforementioned embodiments.

(a) According to the aforementioned embodiments, the cord guard 50 includes the bellows portion 51 and the exit portion 54, which is formed in the trumpet shape. However, the cord guard 50 may not be provided with the exit portion 54 formed in the trumpet shape as long as the cord guard 50 includes the bellows portion 51. Specifically, the cord guard 50 may adapt to only the relatively heavy load and may not adapt to the relatively light load.

(b) According to the aforementioned embodiments, the bellows portion 51 includes four small-diameter portions 511 and three large-diameter portions 512. However, the embodiments in Overview of Embodiments are not limited to this. The bellows portion 51 may include three, five, or more small-diameter portions 511 and two, four, or more large-diameter portions 512.

(c) According to the aforementioned embodiments, the bellows portion 51 is arranged to be on or closer to the center of the intermediate portion 57 than to the coupling portion 55 and to the exit portion 54. However, the embodiments in Overview of Embodiments are not limited to this. For example, the bellows portion 51 may be arranged over the entire intermediate portion 57. Further, the bellows portion 51 may be arranged to be closer to the coupling portion 55 in the intermediate portion 57. Furthermore, the bellows portion 51 may be arranged to be closer to the exit portion 54 in the intermediate portion 57.

(d) Two or more functions of a single element in the aforementioned embodiments may be performed by two or more elements, and a single function of a single element may be performed by two or more elements. Two or more functions performed by two or more elements may be performed by a single element, and a single function performed by two or more elements may be performed by a single element. Part of the configuration in the aforementioned embodiments may be omitted. At least a part of the configuration in the aforementioned embodiments may be added to or replace another configuration in the aforementioned embodiments.

What is claimed is:

1. An electric work machine comprising:
a housing including a cord outlet;
a motor housed in the housing;
a power cord drawn out from the cord outlet, the power cord being configured to be connected to an external power supply so as to supply electric power from the external power supply to the motor; and
a cord guard including:
an internal space through which the power cord passes;
a coupling portion formed to be coupled to the cord outlet;
an exit portion from which the power cord is exposed to an outside; and
an intermediate portion located between the coupling portion and the exit portion, the intermediate portion including large-diameter portions and small-diameter portions, outer diameters of the small-diameter portions are smaller than outer diameters of the large-diameter portions, the large-diameter portions each having a first length in an extending direction of the cord guard, the small-diameter portions each having a second length in the extending direction, the second length being shorter than the first length.

2. The electric work machine according to claim 1,
wherein the exit portion as a first inner diameter, the first inner diameter increasing with distance from the intermediate portion.

3. The electric work machine according to claim 1,
wherein the cord outlet has an inner circumferential surface,
wherein the housing includes a protrusion protruding inward from the inner circumferential surface, and
wherein the coupling portion includes a recess recessed inward in a radial direction of the cord guard so as to be engaged with the protrusion.

4. The electric work machine according to claim 1,
wherein a portion including the large-diameter portions and the small-diameter portions is arranged to be on or closer to a center of the intermediate portion than to the coupling portion and to the exit portion.

5. The electric work machine according to claim 1,
wherein the power cord has a first outer diameter, and
wherein the intermediate portion has a second inner diameter larger than the first outer diameter.

6. The electric work machine according to claim 1,
wherein the first length is three times the second length.

7. The electric work machine according to claim 1,
wherein the second length is 1 mm or more.

8. A cord guard configured to be attached to a power cord drawn out from a cord outlet of a housing, the cord guard comprising:
an internal space allowing the power cord to pass therethrough;
a coupling portion configured to be coupled to the cord outlet;
an exit portion allowing the power cord to be exposed to an outside; and
an intermediate portion located between the coupling portion and the exit portion, the intermediate portion including large-diameter portions and small-diameter portions, outer diameters of the small-diameter portions are smaller than outer diameters of the large-diameter portions, the large-diameter portions each having a first length in an extending direction of the cord guard, the small-diameter portions each having a second length in the extending direction, the second length being shorter than the first length.

9. The cord guard according to claim 8,
wherein the exit portion has a first inner diameter, the first inner diameter increasing with distance from the intermediate portion.

10. The cord guard according to claim 8,
wherein the cord outlet includes an inner circumferential surface and a protrusion protruding inward from the inner circumferential surface, and
wherein the coupling portion includes a recess recessed inward in a radial direction of the cord guard so as to be engaged with the protrusion.

11. The cord guard according to claim 8,
wherein a portion including the large-diameter portions and the small-diameter portions is arranged to be on or closer to a center of the intermediate portion than to the coupling portion and to the exit portion.

12. The cord guard according to claim 8,
wherein the power cord has a first outer diameter, and
wherein the intermediate portion has a second inner diameter larger than the first outer diameter.

13. The cord guard according to claim 8,
wherein the first length is three times the second length.

14. The cord guard according to claim 8,
wherein the second length is 1 mm or more.
